(19) United States
(12) Patent Application Publication
(10) Pub. No.: US 2016/0364084 A1
(43) Pub. Date: Dec. 15, 2016

(54) SYSTEM AND METHOD FOR INTERACTIVE SURFACE USING CUSTOM-BUILT TRANSLUCENT MODELS FOR IMMERSIVE EXPERIENCE

(71) Applicant: Wipro Limited, Bangalore (IN)

(72) Inventor: Sarayu KOSANAM, Gannavaram (IN)

(73) Assignee: Wipro Limited

(21) Appl. No.: 14/814,811

(22) Filed: Jul. 31, 2015

(30) Foreign Application Priority Data
Jun. 9, 2015 (IN) 2869/CHE/2015

(51) Int. Cl. G06F 3/042; G06F 3/01

(52) U.S. Cl. CPC G06F 3/0425; G06F 3/011

(57) ABSTRACT

The disclosure related generally to systems and methods for simple and affordable interactive translucent surface using custom-built translucent models for immersive experience. A first content is projected on the interactive translucent surface. An object is placed on at least one mounting means. The object is detected by an imaging device. Further, a second content is retrieved from a database, wherein the second content is mapped to the detected object. The first content is updated to the second content on the interactive translucent surface.

### PRIORITY CLAIM

This U.S. patent application claims priority under 35 U.S.C. §119 to India Application No. 2689/CHE/2015, filed Jun. 9, 2015. The entire contents of the aforementioned application are incorporated herein by reference.

### TECHNICAL FIELD

This disclosure relates generally to projection of content on an interactive surface, and more particularly to systems and methods for simple and affordable interactive surface using custom-built translucent models for it mersive experience.

### BACKGROUND

Immersive experience is playing a key role in digital world. Interactive surfaces are becoming common components of information based activities. Digital information can be displayed on surface of desks, tables, or walls, and can be manipulated using multi-touch interfaces and tangible input devices. There are quite a few interactive surface solutions available that give immersive experience. Some of them are: a) Bradesco next life cycle; b) ActivTable from Promethean $1825.50 USD

These solutions give a good user experience but are very expensive. Mass deployment and maintenance of these solutions is therefore a challenge. Further, these solutions need plain level surfaces. Also in many scenarios, all features provided by the above solutions may not be needed as the requirement may be to create simple immersive user experience. Due to their expensive nature that results from large number of features, the interactive surface solutions are considered unaffordable for relatively simple applications where less complicated features are required.

In view of the above drawbacks associated with the existing solutions, there is a need to have less costly, easy to customize, and sufficiently effective infrastructure for immersive experience.

### SUMMARY

Disclosed herein is a method of projecting content on an interactive translucent surface. The method includes projecting a first content on the interactive translucent surface; placing at least one object on at least one mounting means; detecting, using at least one imaging device, the at least one object placed on the at least one mounting means; retrieving a second content from a database, the second content being mapped to the detected object; and updating the first content to the second content on the interactive translucent surface.

In an aspect of the invention, a system for projecting content is disclosed. The system includes an interactive translucent surface for displaying a first content; at least one mounting means; at least one imaging device to detect at least one object disposed on the at least one mounting means; a computing device to map the at least one object to a second content, the computing device coupled to the imaging device; and wherein the first content on the interactive translucent surface is modified to the second content in response to the at least one object being mapped to the second content.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates and exemplary system for projecting content on an interactive surface for immersive experience in accordance with some embodiments of the present disclosure; and

FIG. 2 is a flowchart for illustrating an exemplary method of projecting content on the translucent model/surface according to some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

In the present disclosure, the word “exemplary” is used herein to mean “serving as an example, instance, or illustration.” Any embodiment or implementation of the present disclosure described herein as “exemplary” is not necessarily to be construed as preferred or advantageous over other embodiments.

While the present disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “'comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure discloses systems and methods for simple and affordable interactive surface using custom-built translucent models for immersive experience. The present disclosure provides a solution that is affordable, easy to maintain and gives a reasonably good immersive experience. Instead of using only plain level surfaces, the disclosure uses customizable low-cost translucent models of everyday objects which have surfaces for interaction. These everyday objects include books, papers, menu cards in restaurants, etc.

The system uses following components:
A translucent surface (can be plain surface or translucent model of everyday object).
A transparent surface for object detection.
A long throw projector.
An imaging device
An adjustable mirror

The disclosure requires a short throw projector for:
Short distance projection
Avoiding shadows
   These projectors are costly. To reduce cost and avoid shadows, a long throw projector s converted into a short throw projector using a mirror.

The disclosure uses models of everyday objects with affordable material. Further, need for short throw projector is obviated by using a long throw projector and the mirror.

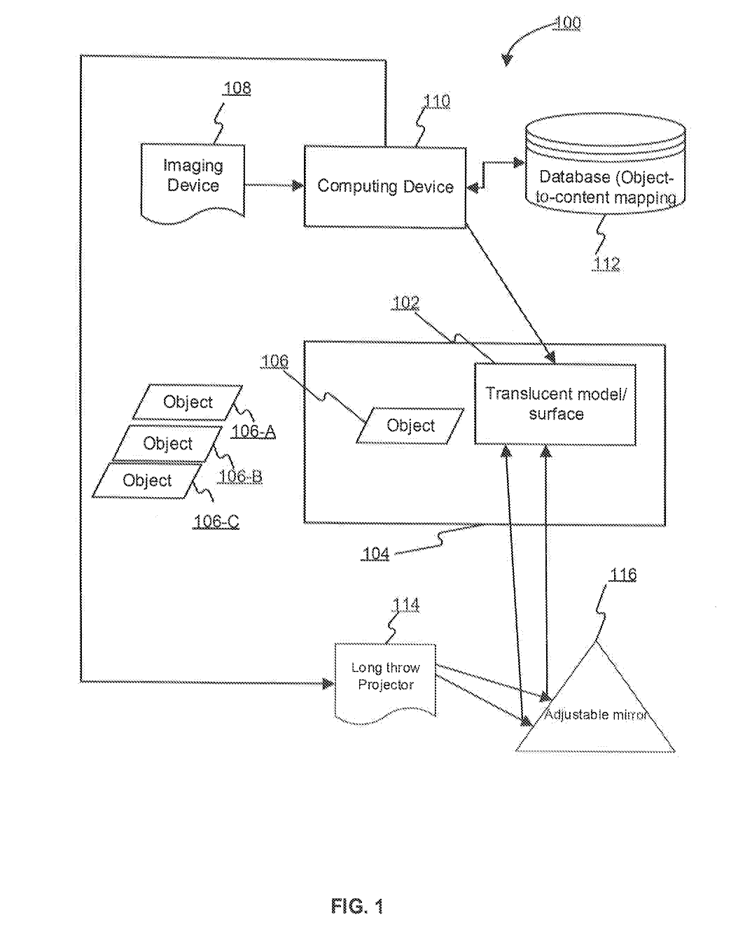

FIG. 1 illustrates and exemplary system 100 for projecting content on an interactive surface for immersive experience in accordance with some embodiments of the present disclosure. Referring to FIG. 1, the system 100 comprises a translucent surface/model 102 disposed on at least one mounting means 104. The mounting means 104 may be a glass table. The mounting means 104 includes at least a portion of it being transparent. The translucent surface/model 102 may be built using low cost material like tracing paper and is an interactive surface. These are real three dimensional models that can be created as per use case. For example, experience of reading a book may be provided by creating a model of the book. Content is projected from beneath onto this model/surface.

Further, an object 106 is placed on the mounting means 104. In an exemplary embodiment, the object 106 is placed on the transparent portion of the mounting means 104. The object 106 may be cards. The object 106 may be selected from a plurality of objects (106-a, 106-b, 106-c . . . ). The object 106 may act as a content cue for changing the projected content on the translucent model/surface 102. According to some embodiments, content cue may be recognized based on color, geometric shape, quick response (QR) code, or text associated with the object 106.

The content cue may be recognized by detecting the object 106. This detection is performed by one or more imaging devices 108. The one or more imaging devices 108 may be low cost cameras. The one or more imaging devices 108 may be communicatively coupled to one or more computing devices 110. In an exemplary embodiment, the one or more computing devices 110 may be tablet, phablet, personal digital assistant (PDA), laptop, personal computer etc.

The one or more computing devices 110 are further in communication with a database 112. The database 112 includes information regarding the mapping of the content cue associated with the object 106 to content stored in the database 112.

Initially, a first content may be displayed on the computing device 110. The first content may be a “Hello” message. The computing device 110 communicates the first content to long throw projector 114 that further communicates the first content to an adjustable mirror 116 that reflects the first content on the translucent model/surface 102, contributing to the cost effectiveness of the system 100. As noted above, the first content is projected from behind (rear projection) on the translucent model/surface 102, thereby avoiding shadows. The arrangement of long throw projector 114 and the adjustable mirror 116 replaces the long throw projector 114 with a short throw projector which is costly.

Further, the object 106 may be detected by the imaging device 108. The detected object 106 is communicated to the computing device 110. Based on the content cue that may be recognized based on color, geometric shape, quick response (QR) code, or text associated with the object 106, a second content mapped to the object 106 is retrieved by the computing device 110. The computing device 110 communicates the second content to the long throw projector 114 that further projects the second content to the adjustable mirror 116 that reflects the second content on the translucent model/surface 102, thereby updating the projected first content to the second content.

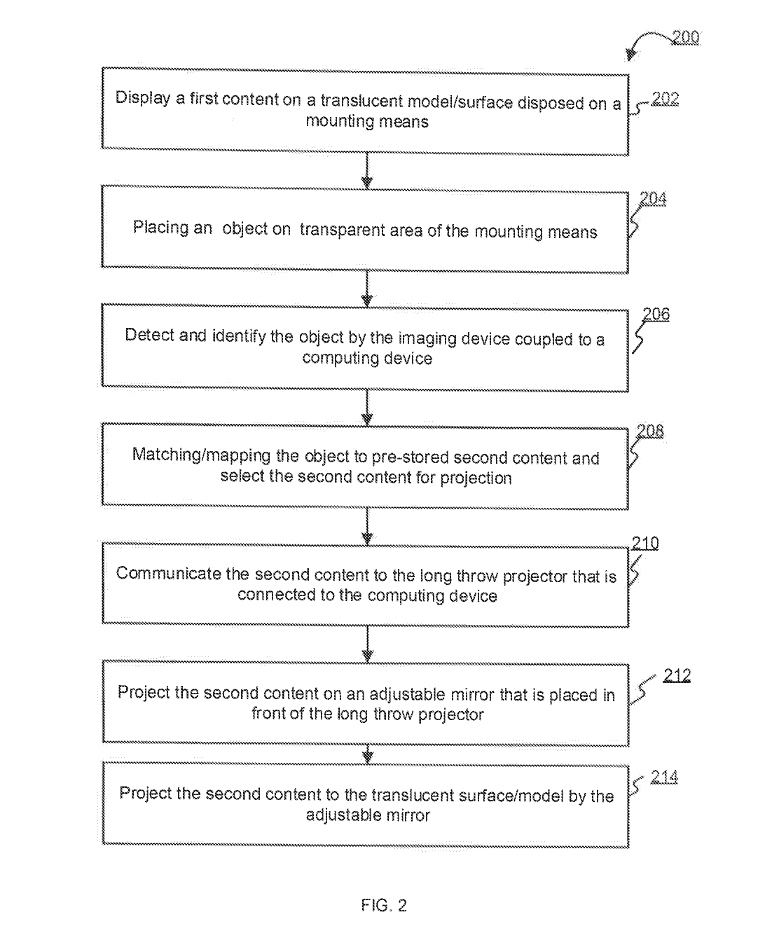

FIG. 2 is a flowchart 200 for illustrating an exemplary method of projecting content on the translucent model/surface 102 according to some embodiments of the present disclosure.

At step 202, the translucent model/surface 102 displays a first content. The first content may be static content. As discussed earlier, the static content may be “Hello” message.

At step 204, the object 106 is placed on the transparent area of the mounting means 104.

At step 206, the object 106 is detected and identified by the imaging device 108 coupled to the computing device 110.

At step 208, the object 106 is matched/mapped to the pre-stored second content and the second content is selected for projection. The second content may be the content of interest to a user or relevant content.

At step 210, the selected second content is communicated to the long throw projector 114 that is connected to the computing device 110.

At step 212, the second content is projected to the adjustable mirror 116 that is placed in front of the long throw projector 114.

At step 214, the adjustable mirror 116 projects the second content to the translucent surface/model 102. The translucent surface/model 102 is placed on the mounting means 104.

The present disclosure offers many advantages. The system 100 is highly affordable for mass deployment. Maintenance of the system 100 is easy because this involves simple set up and low cost materials like tracing paper. The system 100 is not constrained only to plain surfaces. Any customizable translucent model/surface 102 can be created and used that gives reasonably good immersive user experience. The system 100 is cost effective as it can be attached and detached. This helps in making the system portable.

It is intended that the disclosure and examples be considered as exemplary only, with a true scope and spirit of disclosed embodiments being indicated by the following claims.

What is claimed is:

1. A method of projecting content on an interactive translucent surface, the method comprising:
projecting a first content on the interactive translucent surface;
placing at least one object on at least one mounting means;
detecting, using at least one imaging device, the at least one object placed on the at least one mounting means;
retrieving a second content from a database, the second content being mapped to the detected object; and
updating the first content to the second content on the interactive translucent surface.

2. The method of claim 1, wherein projecting the first content on the interactive translucent surface comprises:
projecting, by a long throw projector, the first content on an adjustable mirror; and
reflecting, by the adjustable mirror, the first content on the interactive translucent surface,

3. The method of claim 2, wherein updating the first content to the second content on the interactive translucent surface comprises:
projecting, by the long throw projector, retrieved second content on an adjustable mirror; and
reflecting, by the adjustable mirror, the second content on the interactive translucent surface.

4. The method of claim 1, wherein mapping of the second content to the detected object is based on at least one of a color, a quick response code) QR code, and a geometric shape associated with the detected object.

5. The method of claim 1, further comprising forwarding information associated with the detected object to a computing device, the computing device being communicatively coupled to the imaging device.

6. The method of claim 1, wherein the interactive translucent surface is made from tracing paper.

7. The method of claim 6, wherein the interactive translucent surface is disposed on at least one mounting means, the at least one mounting means comprising at least a transparent portion.

8. The method of claim 7, wherein the mounting means is a transparent table.

9. The method of claim 7, wherein the object is placed on the transparent portion.

10. The method of claim 1, wherein the interactive translucent surface comprises customizable three dimensional model of at least one of book, menu card, and paper.

11. A system for projecting content, the system comprising:
an interactive translucent surface for displaying a first content;
at least one mounting means;
at least one imaging device to detect at least one object disposed on the at least one mounting means;
a computing device to map the at least one object to a second content, the computing device coupled to the imaging device; and
wherein the first content on the interactive translucent surface is modified to the second content in response to the at least one object being mapped to the second content.

12. The system of claim 11, further comprising:
a long throw projector to project the first content on an adjustable mirror; and
an adjustable mirror to reflect the first content on the interactive translucent surface,

13. The system of claim 12, wherein updating the first content to the second content on the interactive translucent surface comprises:
projecting the second content on an adjustable mirror; and
reflecting, by the adjustable mirror, the second content on the interactive translucent surface.

14. The system of claim 11, wherein computing device is configured to map the at least one object to the second content based on at least one of a color, a quick response code) QR code, and a geometric shape associated with the detected object.

15. The system of claim 11, wherein the interactive translucent surface is made from tracing paper.

16. The system of claim 11, wherein the mounting means comprise at least a transparent portion.

17. The system of claim 16, wherein the mounting means is a transparent table.

18. The system of claim 16, wherein the at least one object is placed on the transparent portion.

19. The system of claim 11, wherein the interactive translucent surface comprises customizable three dimensional model of at least one of book, menu card, and paper.
